(19) United States
(12) Patent Application Publication
(10) Pub. No.: US 2026/0346914 A1
(43) Pub. Date: Nov. 5, 2026

(54) STEERING CONTROL METHOD AND STEERING CONTROL DEVICE

(71) Applicant: NISSAN MOTOR CO., LTD., Yokohama-shi, Kanagawa (JP)

(72) Inventors: Kazuhiro IGARASHI, Kanagawa (JP); Noriki KUBOKAWA, Kanagawa (JP); Tomoaki OIDA, Kanagawa (JP)

(21) Appl. No.: 19/118,506

(22) PCT Filed: Oct. 7, 2022
(86) PCT No.: PCT/JP2022/037620

§ 371 Date: Apr. 4, 2025

(51) Int. Cl. B62D 6/00; B62D 15/02

(52) U.S. Cl. CPC B62D 6/008; B62D 15/0215

(57) ABSTRACT

A method includes: providing, when a road surface is a low u road surface and an axial force difference between model axial force or feedforward axial force and feedback axial force is less than a first predetermined value, steering reaction force based on the feedforward axial force; providing, when the road surface is a low μ road surface and the axial force difference is not less than the first predetermined value, steering reaction force based on the feedback axial force; providing, when the road surface is not a low μ road surface and a front wheel slip angle is less than a third predetermined value, steering reaction force based on the feedforward axial force; and providing, when the road surface is not a low μ road surface and the front wheel slip angle is not less than the third predetermined value, steering reaction force based on the feedback axial force.

### TECHNICAL FIELD

The present invention relates to a steering control method and a steering control device.

### BACKGROUND ART

A steering control device described in PTL 1 described below reflects influence of external force exerted on steered wheels on steering reaction force by driving a reaction force motor, based on a control amount of the steering reaction force based on a steering angle and a control amount calculated by multiplying current flowing through a turning motor by a set gain.

### CITATION LIST

### Patent Literature

PTL 1: JP 2000-108914 A

### SUMMARY OF INVENTION

### Technical Problem

In the prior art, the reaction force motor is configured to be driven based on the control amount of the steering reaction force based on the steering angle and the control amount calculated by multiplying the current flowing through the turning motor by the set gain. Therefore, in the prior art, there is a possibility that when, for example, vehicle behavior becomes large, the control amount of the steering reaction force based on the steering angle has an inappropriate value. An object of the present invention is to enable, in a steering control device of a steer-by-wire system in which a steering wheel and steered wheels are mechanically separated, a more appropriate steering reaction force to be provided.

### Solution to Problem

According to an aspect of the present invention, there is provided a steering control method including: providing, when a road surface is a low μ road surface and an axial force difference between one of model axial force, model axial force being steering rack axial force matching an actual turning angle of a steered wheel, and feedforward axial force and feedback axial force is less than a first predetermined value, steering reaction force based on the feedforward axial force without using the feedback axial force; providing, when the road surface is a low μ road surface and the axial force difference is greater than or equal to the first predetermined value, steering reaction force based on the feedback axial force; providing, when the road surface is not a low μ road surface and a front wheel slip angle is less than a third predetermined value, steering reaction force based on the feedforward axial force without using the feedback axial force; and providing when the road surface is not a low μ road surface and the front wheel slip angle is greater than or equal to the third predetermined value, steering reaction force based on the feedback axial force.

### Advantageous Effects of Invention

According to an aspect of the present invention, it is possible to to enable, in a steering control device of a steer-by-wire system in which a steering wheel and steered wheels are mechanically separated, a more appropriate steering reaction force to be provided.

### BRIEF DESCRIPTION OF DRAWINGS

FIG. 1 is a schematic configuration diagram of an example of a steering control device of an embodiment;

FIG. 2 is a block diagram of an example of a functional configuration of a controller;

FIG. 3 is a block diagram of an example of a functional configuration of a target steering reaction force calculation unit;

FIG. 4 is an explanatory diagram of axial force switching control in each traveling scene;

FIG. 5 is a flowchart of an example of a steering control method of the embodiment;

FIG. 6 is a block diagram of an example of a functional configuration of an axial force mixing unit;

FIGS. 7A to 7C are explanatory diagrams of setting examples of mixing ratios;

FIG. 8 is a block diagram of an example of a functional configuration of an axial force difference-dependent mixing ratio calculation unit;

FIGS. 9A and 9B are explanatory diagrams of setting examples of correction gains;

FIGS. 10A and 10B are explanatory diagrams of setting examples of switching range limiting values;

FIG. 11 is an explanatory diagram of a setting example of a bank correction value;

FIG. 12 is an explanatory diagram of a setting example of an axial force difference-dependent mixing ratio;

FIG. 13 is a block diagram of an example of a functional configuration of a front wheel slip angle-dependent mixing ratio calculation unit; and

FIG. 14 is an explanatory diagram of a setting example of a front wheel slip angle-dependent mixing ratio.

### DESCRIPTION OF EMBODIMENTS

### First Embodiment

### (Configuration)

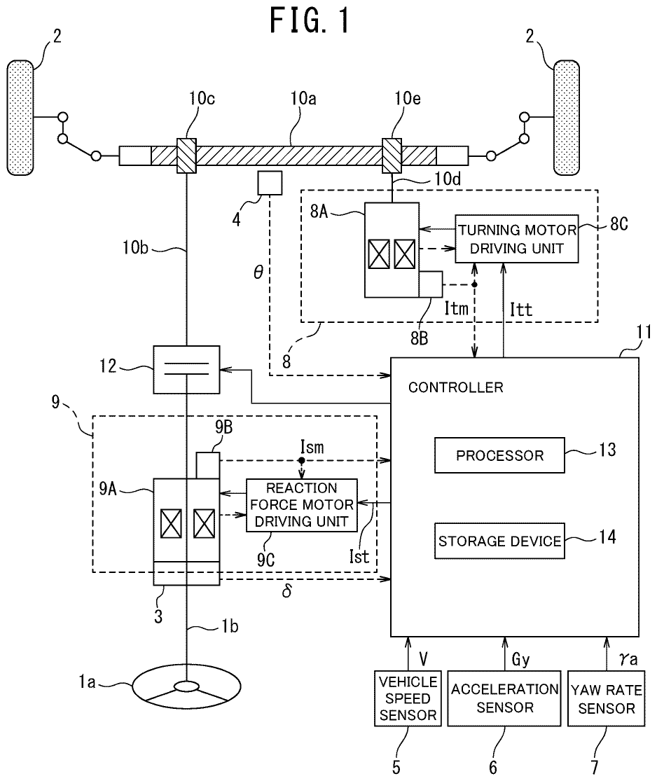

FIG. 1 is a schematic configuration diagram of an example of a steering control device of an embodiment. The steering control device of the embodiment is a steering control device of a steer-by-wire system in which a steering wheel 1a and front wheels 2 that are steered wheels can be mechanically separated. A steering angle sensor 3 detects a steering angle δ of the steering wheel 1a. A turning angle sensor 4 detects an actual turning angle θ of the front wheels (steered wheels) 2. A vehicle speed sensor 5 detects vehicle speed V of an own vehicle. An acceleration sensor 6 detects lateral acceleration Gy exerted on the own vehicle. A yaw rate sensor 7 detects an actual yaw rate γa of the own vehicle. A turning control unit 8 includes a turning motor 8A, a turning current detection unit 8B, and a turning motor driving unit 8C. The turning motor 8A is connected to a pinion shaft 10d via a reduction gear. The turning motor 8A is driven by the turning motor driving unit 8C and laterally moves a steering rack 10a via the pinion shaft 10d and a pinion gear 10e. Because of this configuration, the turning motor 8A turns the front wheels 2. The turning current detection unit 8B detects turning current Itm flowing through the turning motor 8A. The turning current detection unit 8B outputs a signal indicating the turning current Itm to the turning motor driving unit 8C and a controller 11. The turning motor driving unit 8C controls the turning current Itm flowing through the turning motor 8A, based on target turning current Itt that the controller 11 calculates in such a way that the turning current Itm that the turning current detection unit 8B detects coincides with the target turning current Itt. Because of this configuration, the turning motor driving unit 8C drives the turning motor 8A.

A reaction force control unit 9 includes a reaction force motor 9A, a reaction force current detection unit 9B, and a reaction force motor driving unit 9C. The reaction force motor 9A is connected to a steering shaft 1b via a reduction gear. The reaction force motor 9A is driven by the reaction force motor driving unit 9C and provides the steering wheel 1a with rotational torque via the steering shaft 1b. Because of this configuration, the reaction force motor 9A generates steering reaction force. The reaction force current detection unit 9B detects reaction force current Ism flowing through the reaction force motor 9A. The reaction force current detection unit 9B outputs a detection signal indicating the reaction force current Ism to the reaction force motor driving unit 9C and the controller 11. The reaction force motor driving unit 9C controls the reaction force current Ism flowing through the reaction force motor 9A, based on target reaction force current Ist that the controller 11 calculates in such a way that the reaction force current Ism that the reaction force current detection unit 9B detects coincides with the target reaction force current Ist. Because of this configuration, the reaction force motor driving unit 9C drives the reaction force motor 9A.

The backup clutch 12 is disposed between the steering shaft 1b and a pinion shaft 10b. The pinion shaft 10b is connected to the steering rack 10a via a pinion gear 10c, and when the backup clutch 12 is brought into an engaged state, the steering wheel 1a and the front wheels 2 are mechanically connected. When the backup clutch 12 is brought into a released state, the steering wheel 1a and the front wheels 2 are mechanically separated.

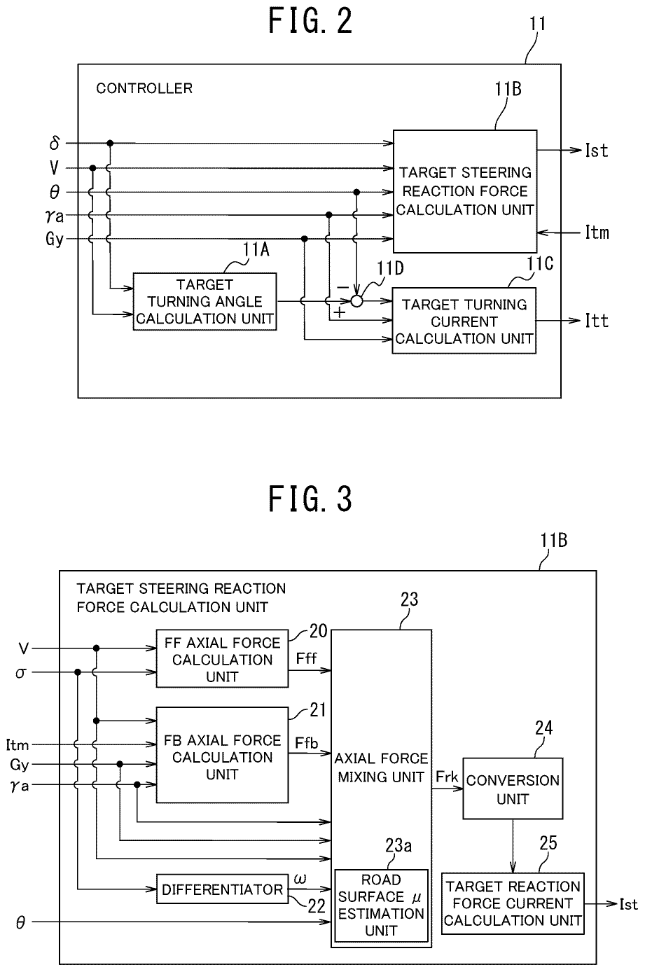

The controller 11 controls driving of the turning motor 8A by the turning control unit 8 and driving of the reaction force motor 9A by the reaction force control unit 9. The controller 11 may include a processor 13 and a peripheral component, such as a storage device 14. Functions of the controller 11 are achieved by, for example, the processor 13 executing computer programs stored in the storage device 14. An example of a functional configuration of the controller 11 is illustrated in FIG. 2. A target turning angle calculation unit 11A calculates a target turning angle θt that is a target value of the actual turning angle θ, based on the steering angle δ and the vehicle speed V. The target turning angle θt may, for example, be calculated by multiplying the steering angle δ by a variable gear ratio. A subtracter 11D calculates deviation Δθ obtained by subtracting the actual turning angle θ from the target turning angle θt. A target turning current calculation unit 11C calculates the target turning current Itt, based on the deviation 40. The target turning current calculation unit 11C outputs the target turning current Itt to the turning motor driving unit 8C.

A target steering reaction force calculation unit 11B calculates the target reaction force current Ist, based on the steering angle δ, the vehicle speed V, the actual turning angle θ, the actual yaw rate γa, the lateral acceleration Gy, and the turning current Itm. The target steering reaction force calculation unit 11B outputs the calculated target reaction force current Ist to the reaction force motor driving unit 9C. FIG. 3 is a block diagram illustrative of an example of a functional configuration of the target steering reaction force calculation unit. Note that in the following description and drawings, feedforward axial force and feedback axial force are sometimes referred to as “FF axial force” and “FB axial force”, respectively. A FF axial force calculation unit 20 calculates FF axial force Fff that is steering rack axial force that provides the steering reaction force matching the steering angle δ, based on the steering angle δ and the vehicle speed V. The steering rack axial force is rack axial force applied to the steering rack 10a. For example, the FF axial force Fff may be calculated based on the target turning angle θt calculated based on the steering angle δ and the vehicle speed V and pinion rigidity, pinion viscosity, rack inertia, and rack viscosity of the pinions and the rack of the steering mechanism. For example, the FF axial force Fff may be axial force applied to the steering rack that includes at least a proportional component matching the target turning angle θt and a damping component matching turning angular velocity.

A FB axial force calculation unit 21 calculates FB axial force Ffb, based on the turning current Itm, the vehicle speed V, the lateral acceleration Gy, and the actual yaw rate γa. The FB axial force Ffb is steering rack axial force through which force transmitted from a road surface to the front wheels 2 is provided to the steering wheel 1a as steering reaction force, which is perceived by the sense of touch of a driver. The FB axial force calculation unit 21 calculates steering rack axial force on which influence of tire lateral force exerted on the steered wheels 2 is reflected, based on the turning current Itm. The steering rack axial force calculated based on the turning current is referred to as “current axial force”.

In addition, the FB axial force calculation unit 21 calculates steering rack axial force on which influence of tire lateral force exerted on the steered wheels 2 is reflected, based on the lateral acceleration Gy. The steering rack axial force calculated based on the lateral acceleration Gy is referred to as “lateral g axial force”. The FB axial force calculation unit 21 calculates steering rack axial force on which influence of tire lateral force exerted on the steered wheels 2 is reflected, based on the actual yaw rate γa. The steering rack axial force calculated based on the actual yaw rate γa is referred to as “yaw rate axial force”. The FB axial force calculation unit 21 calculates the FB axial force Ffb by mixing the current axial force, the lateral g axial force, and the yaw rate axial force.

An axial force mixing unit 23 estimates a front wheel slip angle that is a slip angle of the front wheels 2 and also determines whether or not a road surface on which the own vehicle is traveling is a low μ road surface that has a friction coefficient lower than or equal to a threshold value. The axial force mixing unit 23 includes a road surface u estimation unit 23a configured to determine whether or not the road surface on which the own vehicle is traveling is a low μ road surface. When the road surface is a low μ road surface, the FB axial force Ffb becomes small even when the FF axial force Fff is large. The road surface u estimation unit 23a determines that the road surface is a low μ road surface when the FF axial force Fff is greater than or equal to an upper limit Fff2 and the FB axial force Ffb are less than a lower limit Ffb1. When the FF axial force Fff is less than or equal to a lower limit Fff1 or the FB axial force Ffb is greater than or equal to an upper limit Ffb2, the road surface μ estimation unit 23a determines that the road surface is not a low μ road surface.

When the road surface is a low μ road surface and an axial force difference ΔFs between the FF axial force Fff and the FB axial force Ffb is less than a first predetermined value, the axial force mixing unit 23 calculates an estimated rack axial force Frk, based on the FF axial force Fff without using the FB axial force Ffb. Note that as the axial force difference ΔFs, a difference between model axial force Frm and the FB axial force Ffb may be used. The reason why the model axial force Frm is used is that the model axial force Frm is steering rack axial force calculated based on the actual turning angle θ in accordance with a vehicle model and a difference between the model axial force Frm and the FF axial force Fff is extremely small in a steady state. In addition, when the road surface is a low μ road surface and the axial force difference ΔFs is greater than or equal to the first predetermined value, the axial force mixing unit 23 determines that the own vehicle is in an understeer state (hereinafter, referred to as “US state”) and calculates the estimated rack axial force Frk, based on the FB axial force Ffb. When the road surface is not a low μ road surface and the front wheel slip angle is less than a third predetermined value, the axial force mixing unit 23 calculates the estimated rack axial force Frk, based on the FF axial force Fff without using the FB axial force Ffb, and when the road surface is not a low μ road surface and the front wheel slip angle is greater than or equal to the third predetermined value, the axial force mixing unit 23 determines that the own vehicle is in the US state and calculates the estimated rack axial force Frk, based on the FB axial force Ffb.

A conversion unit 24 converts the estimated rack axial force Frk calculated by the axial force mixing unit 23 to target steering reaction force. The conversion unit 24 may convert the estimated rack axial force to the target steering reaction force, using a conversion map that stores a target steering reaction force corresponding to each value of the estimated rack axial force. A target reaction force current calculation unit 25 calculates target reaction force current, based on the target steering reaction force output from the conversion unit 24. The target reaction force current calculation unit 25 outputs the target reaction force current to the reaction force motor driving unit 9C.

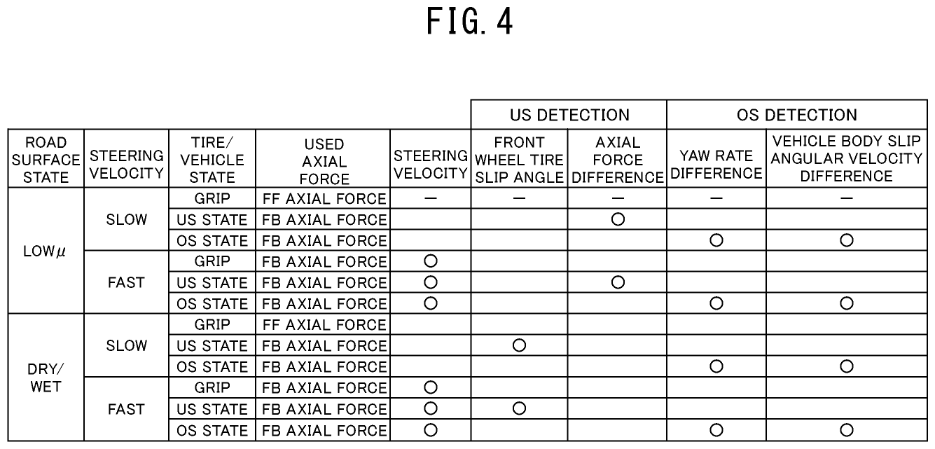

As described above, the controller 11 changes determination of whether or not the own vehicle is in the US state depending on whether or not the road surface is a low μ road surface. The reason for the configuration will be described with reference to FIG. 4.

FIG. 4 is an explanatory diagram of axial force switching control in each traveling scene. When the tires of the own vehicle are in a grip state, the steering reaction force is provided based on the FF axial force Fff. This is because in the case of the grip state, using the FF axial force enables the steering reaction force that is not influenced by disturbance to be provided. On the other hand, when the own vehicle is in an oversteer state (hereinafter, referred to as “OS state”) or the US state, the steering reaction force is provided based on the FB axial force Ffb. This is because using the FB axial force Ffb enables road surface information to be transmitted as the steering reaction force.

Further, when the road surface is not a low μ road surface, whether or not the own vehicle is in the US state is determined based on a front wheel tire slip angle. Determining whether or not the own vehicle is in the US state based on the front wheel slip angle that is information about tire ends enables delay in detection timing of the US state to be reduced. On the other hand, influence of reduction in road surface μ hardly appears in the front wheel slip angle on a low μ road surface. Thus, when the own vehicle is on a low μ road surface, the US state is determined based on the axial force difference that directly reflects the US state due to reduction in the road surface u. Note that whether or not the own vehicle is in the OS state is determined based on a yaw rate difference or a vehicle body slip angular velocity difference.

### (Operation)

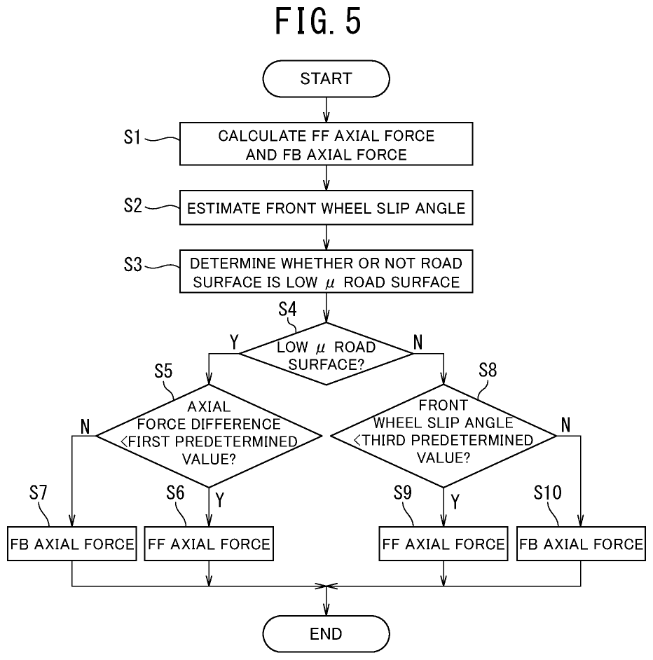

FIG. 5 is a flowchart of an example of a steering control method of the embodiment. In step S1, the controller 11 calculates FF axial force Fff and FB axial force Ffb. In step S2, the controller 11 estimates a front wheel slip angle. In step S3, the controller 11 estimates whether or not the road surface is a low μ road surface. When the road surface is a low μ road surface (step S4: Y), the process proceeds to step S5. When the road surface is not a low μ road surface (step S4: N), the process proceeds to step S10. In step S5, the controller 11 determines whether or not an axial force difference is less than a first predetermined value. When the axial force difference is less than the first predetermined value (step S5: Y), the process proceeds to step S6. When the axial force difference is not less than the first predetermined value (step S5: N), the process proceeds to step S7. In step S6, the controller 11 provides steering reaction force based on the FF axial force Fff, and in step S7, the controller 11 provides steering reaction force based on the FB axial force Ffb. Subsequently, the process terminates.

In step S8, the controller 11 determines whether or not the front wheel slip angle is less than a third predetermined value. When the front wheel slip angle is less than the third predetermined value (step S8: Y), the process proceeds to step S9. When the front wheel slip angle is not less than the third predetermined value (step S8: N), the process proceeds to step S10. In step S9, the controller 11 provides steering reaction force based on the FF axial force Fff, and in step S10, the controller 11 provides steering reaction force based on the FB axial force Ffb. Subsequently, the process terminates.

### (Variation)

The axial force mixing unit 23 may set a larger first predetermined value when a bank angle of the road surface is large than when the bank angle is small. Because of this configuration, influence of estimation error of the FB axial force Ffb due to a bank can be reduced. For example, the axial force mixing unit 23 calculates a lateral g offset Gyo that is lateral acceleration to be added to the lateral acceleration Gy, which is output by the acceleration sensor 6, due to influence of the bank angle or a cant of the road surface. For example, the axial force mixing unit 23 may calculate the lateral g offset Gyo=V×γa−Gy, based on the vehicle speed V, the actual yaw rate γa, and the lateral acceleration Gy. The axial force mixing unit 23 calculates a bank correction value Cb that is a correction value for correcting the first predetermined value and a second predetermined value in such a way that the first predetermined value and the second predetermined value match the bank correction value Cb. FIG. 11 is now referred to. The bank correction value Cb increases from “0” to a value Cb2 as the lateral g offset Gyo increases. For example, the bank correction value Cb is “0” in a range where the lateral g offset Gyo is less than a value Gy1, increases from “0” to a value Cb1 as the lateral g offset Gyo increases from the value Gy1 to a value Gy2, and increases from the value Cb1 to the value Cb2 as the lateral g offset Gyo increases from the value Gy2 to a value Gy3. The axial force mixing unit 23 corrects the first predetermined value and the second predetermined value by adding the bank correction value Cb. Because of this configuration, the first predetermined value becomes larger when the bank angle of the road surface is large.

### Second Embodiment

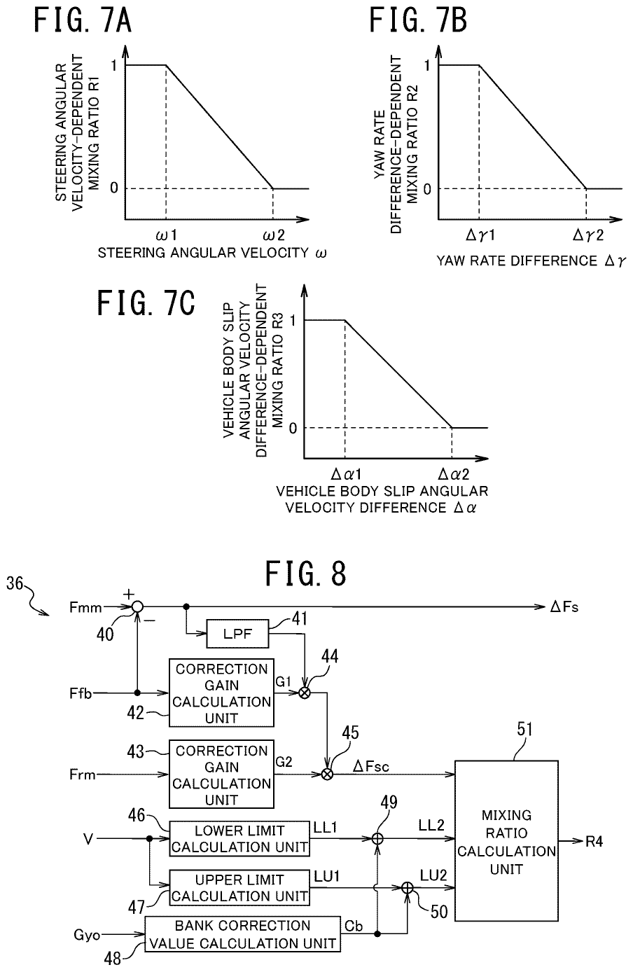

In a second embodiment, when steering velocity ω of a steering wheel 1a is greater than or equal to a predetermined velocity, steering reaction force based on FB axial force is provided. FIG. 3 is now referred to. A differentiator 22 calculates steering angular velocity ω of the steering wheel 1a by differentiating a steering angle δ. An axial force mixing unit 23 determines whether or not the steering velocity ω is greater than or equal to the predetermined velocity. When the steering velocity ω is greater than or equal to the predetermined velocity, the axial force mixing unit 23 calculates estimated rack axial force Frk, based on the FB axial force Ffb regardless of whether or not a road surface is a low μ road surface, whether or not an axial force difference ΔFs is greater than or equal to a second predetermined value, and whether or not a front wheel slip angle is greater than or equal to a fourth predetermined value. For example, the axial force mixing unit 23 may calculate the estimated rack axial force Frk by calculating a steering angular velocity-dependent mixing ratio R1 matching steering angular velocity ω and mixing FF axial force Fff and the FB axial force Ffb at the steering angular velocity-dependent mixing ratio R1. The steering angular velocity-dependent mixing ratio R1 is set in such a way that when the steering angular velocity ω is high, a ratio of the FF axial force Fff is reduced. FIG. 7A is now referred to. The steering angular velocity-dependent mixing ratio R1 transitions from “1” to “0” as the steering angular velocity ω increases. For example, in a range where the steering angular velocity ω is lower than a lower limit ω1, the steering angular velocity-dependent mixing ratio R1 is “1”. In a range where the steering angular velocity ω is higher than an upper limit ω2, the steering angular velocity-dependent mixing ratio R1 is “0”. In a range from the lower limit ω1 to the upper limit ω2, the steering angular velocity-dependent mixing ratio R1 decreases from “1” to “0” as the steering angular velocity ω increases. The lower limit ω1 and the upper limit ω2 may be made variable according to vehicle speed V. The axial force mixing unit 23 may calculate the estimated rack axial force Frk=R1×Fff+(1−R1)×Ffb by mixing the FF axial force Fff and the FB axial force Ffb at the steering angular velocity-dependent mixing ratio R1.

### Third Embodiment

In a third embodiment, steering reaction force based on FB axial force is provided when an own vehicle is in an OS state, in addition to performing the control in the first embodiment and the second embodiment. For example, when the own vehicle is in the OS state, a yaw rate difference Δγ that is a difference between a model yaw rate γm, the model yaw rate γm being a model value of a yaw rate that is calculated in accordance with a vehicle model, and an actual yaw rate γa increases. Thus, when the yaw rate difference Δγ is large, steering reaction force based on the FB axial force is provided. In addition, when, for example, the own vehicle is in the OS state, a vehicle body slip angular velocity difference Δα that is a difference between a model vehicle body slip angular velocity am, the model vehicle body slip angular velocity om being a model value of a vehicle body slip angular velocity that is calculated in accordance with the vehicle model, and an actual vehicle body slip angular velocity xa increases. Thus, when the vehicle body slip angular velocity difference Δα is large, steering reaction force based on the FB axial force is provided.

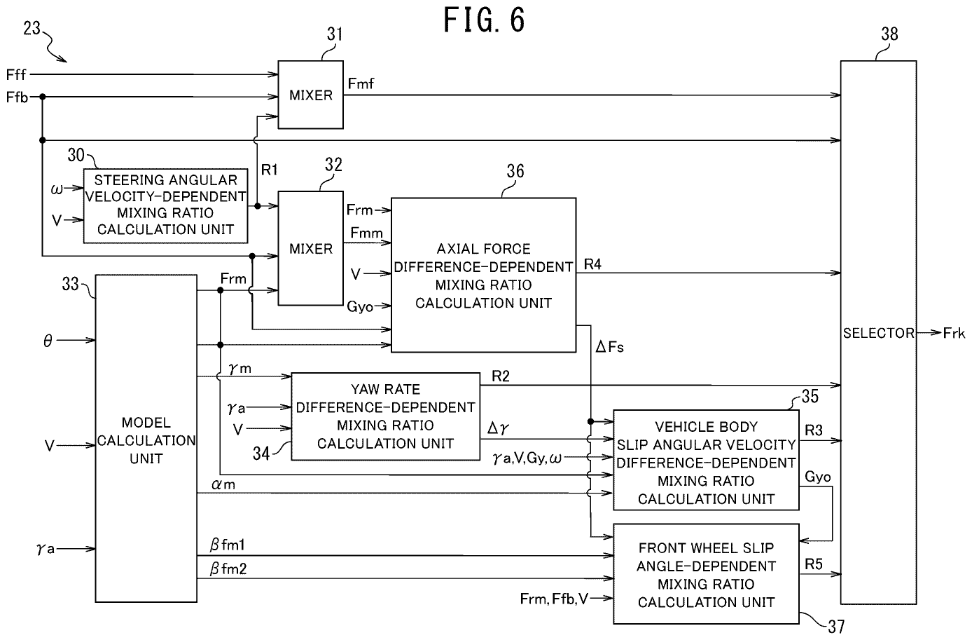

FIG. 6 is a block diagram of an example of a functional configuration of an axial force mixing unit 23 of the third embodiment. The axial force mixing unit 23 calculates first mixed axial force Fmf by calculating a steering angular velocity-dependent mixing ratio R1 matching steering angular velocity ω and mixing FF axial force Fff and FB axial force Ffb at the steering angular velocity-dependent mixing ratio R1. In addition, the axial force mixing unit 23 calculates a yaw rate difference-dependent mixing ratio R2 matching the yaw rate difference Δγ, a vehicle body slip angular velocity difference-dependent mixing ratio R3 matching the vehicle body slip angular velocity difference Δx, an axial force difference-dependent mixing ratio R4 matching an axial force difference ΔFs, and a front wheel slip angle-dependent mixing ratio R5 matching a front wheel slip angle. The axial force mixing unit 23 selects one of the mixing ratios R2 to R5 depending on a traveling scene as a final mixing ratio Rf. The axial force mixing unit 23 calculates estimated rack axial force Frk by mixing the first mixed axial force Fmf and the FB axial force Ffb at the final mixing ratio Rf.

The axial force mixing unit 23 includes a steering angular velocity-dependent mixing ratio calculation unit 30, mixers 31 and 32, a model calculation unit 33, a yaw rate difference-dependent mixing ratio calculation unit 34, a vehicle body slip angular velocity difference-dependent mixing ratio calculation unit 35, an axial force difference-dependent mixing ratio calculation unit 36, a front wheel slip angle-dependent mixing ratio calculation unit 37, and a selector 38. The steering angular velocity-dependent mixing ratio calculation unit 30 calculates the steering angular velocity-dependent mixing ratio R1, based on at least the steering angular velocity ω, as described above with reference to FIG. 7A. The mixer 31 calculates the first mixed axial force Fmf=R1×Fff+(1−R1)×Ffb by mixing the FF axial force Fff and the FB axial force Ffb at the steering angular velocity-dependent mixing ratio R1. The mixer 32 calculates second mixed axial force Fmm=R1×Frm+(1−R1)×Ffb by mixing model axial force Frm and the FB axial force Ffb at the steering angular velocity-dependent mixing ratio R1.

The model calculation unit 33 calculates the model yaw rate γm and the model vehicle body slip angular velocity αm, based on an actual turning angle θ and vehicle speed V in accordance with a predetermined linear two-wheel model. An example of the linear two-wheel model is expressed by the following formula.

$${F}_{Yf} = 2 {K}_{f} ( \frac{{V}_{y}}{{V}_{x}} + \frac{{L}_{f}}{{V}_{x}} γ m - {θ}_{f} ) \qquad [ Math . 1 ]$$

$${F}_{Yr} = 2 {K}_{r} ( \frac{{V}_{y}}{{V}_{x}} + \frac{{L}_{r}}{{V}_{x}} γ m - {θ}_{r} )$$

$${I}_{z} \frac{d γ m}{dt} = {L}_{f} {F}_{Yf} - {L}_{r} {F}_{Yr}$$

$$M \frac{{dV}_{y}}{dt} = {F}_{Yf} + {F}_{Yr} - {MV}_{x} \frac{d γ m}{dt}$$

$$α m = \frac{\frac{{dV}_{y}}{dt}}{{V}_{x}}$$

Vₓ is longitudinal speed of the own vehicle, V_{y} is lateral speed, θ_{f} is turning angle of front wheels, θᵣ is turning angle of rear wheels, M is mass of the own vehicle, I_{z} is inertia moment, L_{f} is length from the center of gravity to the front wheels, Lᵣ is length from the center of gravity to the rear wheels, K_{f} is cornering power of the front wheels, and Kr is cornering power of the rear wheels. In addition, the model calculation unit 33 calculates a first estimated front wheel slip angle βfm1 that is a front wheel slip angle calculated based on the actual yaw rate γa and a second estimated front wheel slip angle βfm2 that is a front wheel slip angle calculated based on the model yaw rate γm. For example, the model calculation unit 33 may calculate the first estimated front wheel slip angle βfm1 and the second estimated front wheel slip angle βfm2 in accordance with the following formula.

βfm1=θ/N−(V_{y}+L_{f}×γa)/Vₓ

βfm2=θ/N−(V_{y}+L_{f}×γm)/Vₓ

In the above formula, N is an overall gear ratio. Further, the model calculation unit 33 calculates the model axial force Frm, based on the actual turning angle θ. For example, the model calculation unit 33 may estimate tire lateral force of the front wheels 2 by multiplying the first estimated front wheel slip angle βfm1 or the second estimated front wheel slip angle βfm2 by the front wheel cornering power K_{f} and convert the estimated tire lateral force to the model axial force Frm.

The yaw rate difference-dependent mixing ratio calculation unit 34 calculates the yaw rate difference-dependent mixing ratio R2 for calculating the estimated rack axial force Frk, based on the FB axial force Ffb when the own vehicle is in the OS state. The yaw rate difference-dependent mixing ratio R2 may be calculated based on at least the model yaw rate γm and the actual yaw rate γa. The yaw rate difference-dependent mixing ratio R2 is set in such a way that when the yaw rate difference Δγ between the model yaw rate γm and the actual yaw rate γa is large, a ratio of the first mixed axial force Fmf is reduced (in such a way that a ratio of the FF axial force Fff is reduced). FIG. 7B is now referred to. The yaw rate difference-dependent mixing ratio R2 transitions from “1” to “0” as the yaw rate difference Δγ increases. For example, in a range where the yaw rate difference Δγ is less than a lower limit Δγ1, the yaw rate difference-dependent mixing ratio R2 is “1”. In a range where the yaw rate difference Δγ is greater than an upper limit Δγ2, the yaw rate difference-dependent mixing ratio R2 is “0”. In a range from the lower limit Δγ1 to the upper limit Δγ2, the yaw rate difference-dependent mixing ratio R2 decreases from “1” to “0” as the yaw rate difference Δγ increases. The lower limit Δγ1 and the upper limit Δγ2 may be made variable according to vehicle speed V.

FIG. 6 is now referred to. The vehicle body slip angular velocity difference-dependent mixing ratio calculation unit 35 calculates the vehicle body slip angular velocity difference-dependent mixing ratio R3 for calculating the estimated rack axial force Frk, based on the FB axial force Ffb when the own vehicle is in the OS state. The vehicle body slip angular velocity difference-dependent mixing ratio calculation unit 35 calculates, based on the vehicle speed V, the actual yaw rate γa, and the lateral acceleration Gy, the actual vehicle body slip angular velocity αa=γa−Gy/V, calculates the vehicle body slip angular velocity difference Δα between the model vehicle body slip angular velocity αm and the actual vehicle body slip angular velocity xa, and calculates, based on the vehicle body slip angular velocity difference Δα, the vehicle body slip angular velocity difference-dependent mixing ratio R3. The vehicle body slip angular velocity difference-dependent mixing ratio R3 is set in such a way that when the vehicle body slip angular velocity difference Δα is large, the ratio of the first mixed axial force Fmf is reduced.

FIG. 7C is now referred to. The vehicle body slip angular velocity difference-dependent mixing ratio R3 transitions from “1” to “0” as the vehicle body slip angular velocity difference Δα increases. For example, in a range where the vehicle body slip angular velocity difference Δα is less than a lower limit Δα1, the vehicle body slip angular velocity difference-dependent mixing ratio R3 is “1”. In a range where the vehicle body slip angular velocity difference Δα is greater than an upper limit Δα2, the vehicle body slip angular velocity difference-dependent mixing ratio R3 is “0”. In a range from the lower limit Δα1 to the upper limit Δα2, the vehicle body slip angular velocity difference-dependent mixing ratio R3 decreases from “1” to “0” as the vehicle body slip angular velocity difference Δα increases. The lower limit Δα1 and the upper limit Δα2 may be made variable according to vehicle speed V. FIG. 6 is now referred to. The vehicle body slip angular velocity difference-dependent mixing ratio calculation unit 35 calculates the above-described lateral g offset Gyo.

The axial force difference-dependent mixing ratio calculation unit 36 calculates the axial force difference-dependent mixing ratio R4. FIG. 8 is now referred to. The axial force difference-dependent mixing ratio calculation unit 36 includes a subtracter 40, a low-pass filter 41, correction gain calculation units 42 and 43, multipliers 44 and 45, a lower limit calculation unit 46, an upper limit calculation unit 47, a bank correction value calculation unit 48, adders 49 and 50, and a mixing ratio calculation unit 51. The subtracter 40 calculates the axial force difference ΔFs between the second mixed axial force Fmm and the FB axial force Ffb. The subtracter 40 may calculate an axial force difference between the FF axial force Fff, in place of the second mixed axial force Fmm, and the FB axial force Ffb as the axial force difference ΔFs. The axial force difference ΔFs having high frequency components removed by the low-pass filter 41 is input to the multiplier 44.

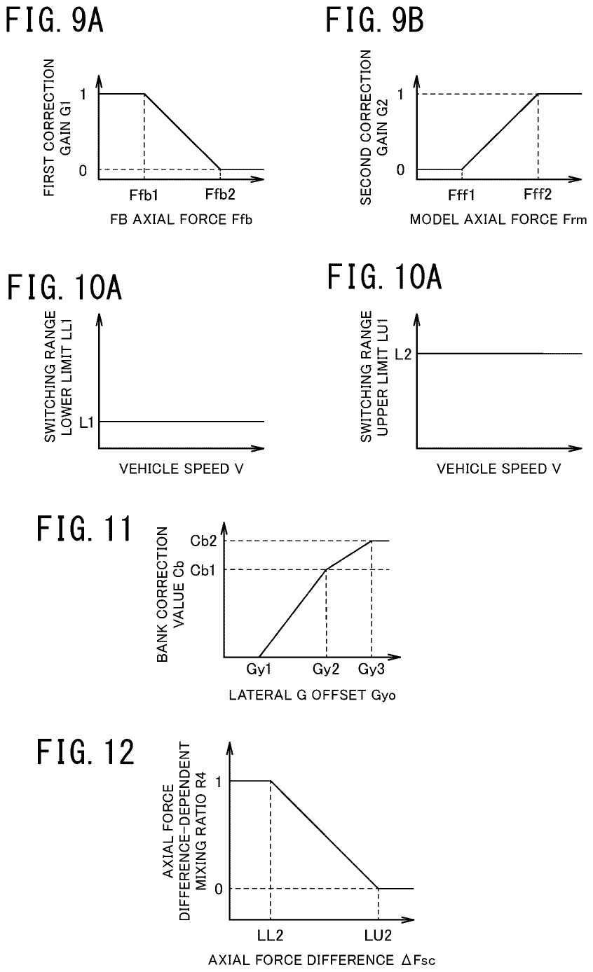

The correction gain calculation units 42 and 43 calculate a first correction gain G1 and a second correction gain G2 matching whether or not a road surface is a low μ road surface, respectively. Because of this configuration, the axial force difference-dependent mixing ratio calculation unit 36 calculates the axial force difference-dependent mixing ratio R4 matching the axial force difference ΔFs when the road surface is a low μ road surface and fixes the axial force difference-dependent mixing ratio R4 to “1” when the road surface is not a low μ road surface. When the road surface is a low μ road surface, the FB axial force Ffb becomes small even when the FF axial force Fff is large. Therefore, the correction gain calculation units 42 and 43 determines that the road surface is a low μ road surface when the FF axial force Fff is greater than or equal to the upper limit Fff2 and the FB axial force Ffb is less than the lower limit Ffb1 and sets the first correction gain G1 and the second correction gain G2 to “1”. FIG. 9A is now referred to. The first correction gain G1 transitions from “1” to “0” as the FB axial force Ffb increases. For example, in a range where the FB axial force Ffb is less than the lower limit Ffb1, the first correction gain G1 is “1”, and in a range where the FB axial force Ffb is greater than the upper limit Ffb2, the first correction gain G1 is “0”. In a range from the lower limit Ffb1 to the upper limit Ffb2, the first correction gain G1 decreases from “1” to “0” as the FB axial force Ffb increases.

Conversely, when the FF axial force Fff is less than or equal to the lower limit Fff1 or the FB axial force Ffb is greater than or equal to the upper limit Ffb2, the correction gain calculation units 42 and 43 determines that the road surface is not a low μ road surface and sets the first correction gain G1 and the second correction gain G2 to “0”. FIG. 9B is now referred to. The second correction gain G2 transitions from “0” to “1” as the model axial force Frm increases. For example, in a range where the model axial force Frm is less than the lower limit Fff1, the second correction gain G2 is “0”, and in a range where the model axial force Frm is greater than the upper limit Fff2, the second correction gain G2 is “1”. In a range from the lower limit Fff to the upper limit Fff2, the second correction gain G2 increases from “0” to “1” as the model axial force Frm increases. The multipliers 44 and 45 calculate a corrected axial force difference ΔFsc=G1×G2×ΔFs. The mixing ratio calculation unit 51 calculates the axial force difference-dependent mixing ratio R4, based on the axial force difference ΔFsc. Because of this configuration, when the road surface is a low μ road surface, the axial force difference ΔFs is input to the mixing ratio calculation unit 51 without change. Thus, the mixing ratio calculation unit 51 calculates the axial force difference-dependent mixing ratio R4 matching the axial force difference ΔFs. On the other hand, when the road surface is not a low μ road surface, the axial force difference ΔFsc=0 is input to the mixing ratio calculation unit 51, and the axial force difference-dependent mixing ratio R4 is fixed to “1” as described later.

The lower limit calculation unit 46 calculates a switching range lower limit LL1 that is a lower limit of a switching range where the axial force difference-dependent mixing ratio R4 is switched between “1” and “0” according to the axial force difference ΔFsc. The upper limit calculation unit 47 calculates a switching range upper limit LU1 that is an upper limit of the switching range. For example, the lower limit calculation unit 46 and the upper limit calculation unit 47 may calculate the switching range lower limit LL1 and the switching range upper limit LU1 according to the vehicle speed V, respectively. FIG. 10A is now referred to. The switching range lower limit LL1 may be a constant value L1 at any vehicle speed V or may be made variable according to the vehicle speed. FIG. 10B is now referred to. The switching range upper limit LU1 may be a constant value L2 at any vehicle speed V or may be made variable according to the vehicle speed.

FIG. 8 is now referred to. The bank correction value calculation unit 48 calculates the bank correction value Cb that is described above with reference to FIG. 11. The adders 49 and 50 add the bank correction value Cb to the switching range lower limit LL1 and the switching range upper limit LU1 and thereby calculate a corrected switching range lower limit LL2=LL1+Cb and a corrected switching range upper limit LU2=LU1+Cb, respectively. As described above, the larger a bank angle or a cant of the road surface is, the larger a value of the lateral g offset Gyo becomes. Therefore, the larger the bank angle or the cant of the road surface is, the larger values the switching range lower limit LL2 and the switching range upper limit LU2 are set to.

The mixing ratio calculation unit 51 calculates the axial force difference-dependent mixing ratio R4, based on the axial force difference ΔFsc. The axial force difference-dependent mixing ratio R4 is set in such a way that when the axial force difference ΔFsc is large, the ratio of the first mixed axial force Fmf is reduced.

FIG. 12 is now referred to. The axial force difference-dependent mixing ratio R4 transitions from “1” to “0” as the axial force difference ΔFsc increases. For example, in a range where the axial force difference ΔFsc is less than the switching range lower limit LL2, the axial force difference-dependent mixing ratio R4 is “1”. Thus, since when the road surface is not a low μ road surface, ΔFsc=0 is input, the axial force difference-dependent mixing ratio R4 is fixed to “1”. In a range where the axial force difference ΔFsc is greater than the switching range upper limit LU2, the axial force difference-dependent mixing ratio R4 is “0”. In a range from the switching range lower limit LL2 to the switching range upper limit LU2, the axial force difference-dependent mixing ratio R4 decreases from “1” to “0” as the axial force difference ΔFsc increases. The switching range lower limit LL2 and the switching range upper limit LU2 are examples of a “first predetermined value” and a “second predetermined value” described in the claims, respectively.

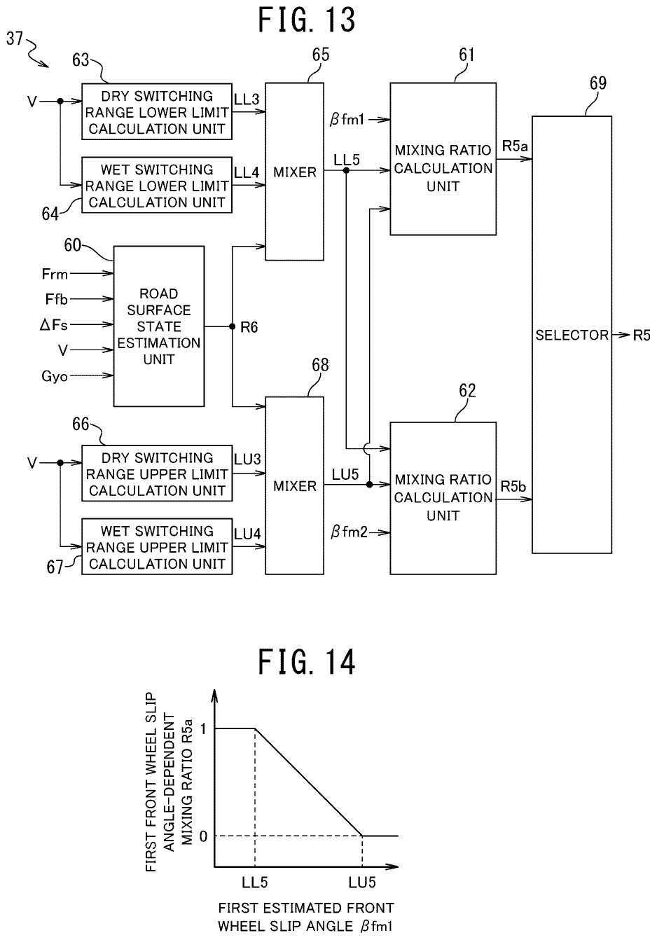

FIG. 13 is now referred to. The front wheel slip angle-dependent mixing ratio calculation unit 37 calculates the front wheel slip angle-dependent mixing ratio R5. The front wheel slip angle-dependent mixing ratio calculation unit 37 includes a road surface state estimation unit 60, mixing ratio calculation units 61 and 62, a DRY switching range lower limit calculation unit 63, a WET switching range lower limit calculation unit 64, mixers 65 and 68, a DRY switching range upper limit calculation unit 66, a WET switching range upper limit calculation unit 67, and a selector 69. The road surface state estimation unit 60 determines a dry state (or a wet state) of the road surface based on the axial force difference ΔFs and calculates a mixing ratio R6 matching the dry state (or the wet state) of the road surface. The mixing ratio R6 transitions from “1” to “0” as the axial force difference ΔFs increases. Therefore, the mixing ratio R6 is “1” when the road surface is dry and decreases to “0” as the road surface becomes wet. The road surface state estimation unit 60 may, as with the correction gain calculation units 42 and 43 and the multipliers 44 and 45 in FIG. 8, correct the axial force difference ΔFs, using correction gains matching the FB axial force Ffb and the model axial force Frm and calculate the mixing ratio R6 according to the corrected axial force difference. In addition, the road surface state estimation unit 60 may, as with the lower limit calculation unit 46, the upper limit calculation unit 47, the bank correction value calculation unit 48, and the adders 49 and 50, set a lower limit and an upper limit of a switching range where the mixing ratio R6 is caused to transition between “1” and “0”, according to the vehicle speed V.

The mixing ratio calculation unit 61 calculates a first front wheel slip angle-dependent mixing ratio R5a, based on the first estimated front wheel slip angle βfm1. The first front wheel slip angle-dependent mixing ratio R5a is set in such a way that when the first estimated front wheel slip angle βfm1 is large, a ratio of the first mixed axial force Fmf is reduced. FIG. 14 is now referred to. The first front wheel slip angle-dependent mixing ratio R5a transitions from “1” to “0” as the first estimated front wheel slip angle βfm1 increases. For example, in a range where the first estimated front wheel slip angle βfm1 is less than a switching range lower limit LL5, the first front wheel slip angle-dependent mixing ratio R5a is “1”. In a range where the first estimated front wheel slip angle βfm1 is greater than a switching range upper limit LU5, the first front wheel slip angle-dependent mixing ratio R5a is “0”. In a range from the switching range lower limit LL5 to the switching range upper limit LU5, the first front wheel slip angle-dependent mixing ratio R5a decreases from “1” to “0” as the first estimated front wheel slip angle βfm1 increases. The switching range lower limit LL5 and the switching range upper limit LU5 are examples of a “third predetermined value” and a “fourth predetermined value” described in the claims, respectively.

The mixing ratio calculation unit 62 calculates a second front wheel slip angle-dependent mixing ratio R5b, based on the second estimated front wheel slip angle βfm2. A calculation method of the second front wheel slip angle-dependent mixing ratio R5b is the same as the calculation method of the first front wheel slip angle-dependent mixing ratio R5a except that the second estimated front wheel slip angle βfm2 is used in place of the first estimated front wheel slip angle βfm1.

The DRY switching range lower limit calculation unit 63, the WET switching range lower limit calculation unit 64, and the mixer 65 calculate the switching range lower limit LL5. For example, the DRY switching range lower limit calculation unit 63 and the WET switching range lower limit calculation unit 64 calculate a switching range lower limit LL3 for the dry state and a switching range lower limit LL4 for the wet state, respectively. The switching range lower limits LL3 and LL4 may be constant values at any vehicle speed V or may be made variable according to the vehicle speed. The mixer 65 calculates the switching range lower limit LL5 by mixing the switching range lower limits LL3 and LL4 at the mixing ratio R6. The DRY switching range upper limit calculation unit 66, the WET switching range upper limit calculation unit 67, and the mixer 68 calculate the switching range upper limit LU5. For example, the DRY switching range upper limit calculation unit 66 and the WET switching range upper limit calculation unit 67 calculate a switching range upper limit LU3 for the dry state and a switching range upper limit LU4 for the wet state, respectively. The switching range upper limits LU3 and LU4 may be constant values at any vehicle speed V or may be made variable according to the vehicle speed. The mixer 68 calculates the switching range upper limit LU5 by mixing the switching range upper limits LU3 and LU4 at the mixing ratio R6. The selector 69 selects and outputs one of the first front wheel slip angle-dependent mixing ratio R5a and the second front wheel slip angle-dependent mixing ratio R5b that is smaller than the other as the front wheel slip angle-dependent mixing ratio R5.

FIG. 6 is now referred to. The selector 38 selects one of the mixing ratios R2 to R5 according to a traveling scene as the final mixing ratio Rf. For example, when the yaw rate difference-dependent mixing ratio R2 is less than “1”, the selector 38 may determine that the own vehicle is in the OS state and select the yaw rate difference-dependent mixing ratio R2. In addition, when the vehicle body slip angular velocity difference-dependent mixing ratio R3 is less than “1”, the selector 38 may determine that the own vehicle is in the OS state and select the vehicle body slip angular velocity difference-dependent mixing ratio R3. In addition, when the axial force difference-dependent mixing ratio R4 is less than “1”, the selector 38 may determine that the own vehicle is in the US state and the road surface is a low μ road surface and select the axial force difference-dependent mixing ratio R4. In addition, when the front wheel slip angle-dependent mixing ratio R5 is less than “1”, the selector 38 may determine that the own vehicle is in the US state and the road surface is a low μ road surface and select the front wheel slip angle-dependent mixing ratio R5.

Note that the selector 38 may select a smallest one of the mixing ratios R2 to R5 as the final mixing ratio Rf. The selector 38 may calculate mixed axial force obtained by mixing the first mixed axial force Fmf and the FB axial force Ffb at the final mixing ratio Rf, as the estimated rack axial force Frk. Because of this configuration, sudden change in the steering reaction force due to the estimated rack axial force Frk suddenly switching between the FF axial force Fff and the FB axial force Ffb can be mitigated.

### Advantageous Effects of Embodiment

(1) In the steering control method, when a road surface is a low μ road surface and an axial force difference is less than a first predetermined value, steering reaction force based on FF axial force is provided, and when the road surface is a low μ road surface and the axial force difference is greater than or equal to a second predetermined value, the second predetermined value being greater than or equal to the first predetermined value, steering reaction force based on FB axial force is provided. Because of this configuration, since when the road surface is a low μ road surface, the FF axial force and the FB axial force can be switched according to an axial force difference that enables u reduction to be detected, the steering reaction force can be rapidly switched to steering reaction force based on the FB axial force when the vehicle is in the US state and a driver can be appropriately informed of reduction in road surface u.

When the road surface is not a low μ road surface and a front wheel slip angle is less than a third predetermined value, steering reaction force based on the FF axial force is provided, and when the road surface is not a low μ road surface and the front wheel slip angle is greater than or equal to a fourth predetermined value, the fourth predetermined value being greater than or equal to the third predetermined value, steering reaction force based on the FB axial force is provided. Because of this configuration, when the road surface is not a low μ road surface, the steering reaction force can be rapidly switched to steering reaction force based on the FB axial force when the vehicle is in the US state and the driver can be appropriately informed of road surface state.
(2) When steering velocity is greater than or equal to a predetermined velocity, steering reaction force based on the FB axial force may be provided regardless of whether or not the road surface is a low μ road surface and whether or not the front wheel slip angle is greater than or equal to the fourth predetermined value. Because of this configuration, in an emergency avoidance scene, the steering reaction force can be switched based on the FB axial force that enables the driver to be appropriately informed of road surface state.
(3) When a difference between a model yaw rate and an actual yaw rate is greater than a predetermined value, steering reaction force based on the FB axial force may be provided regardless of whether or not the road surface is a low μ road surface and whether or not the front wheel slip angle is greater than or equal to the fourth predetermined value.

In addition, when a difference between a model vehicle body slip angular velocity and an actual vehicle body slip angular velocity is greater than a predetermined value, steering reaction force based on the FB axial force may be provided regardless of whether or not the road surface is a low μ road surface and whether or not the front wheel slip angle is greater than or equal to the fourth predetermined value. Because of this configuration, when the vehicle is in the OS state, the steering reaction force can be switched to steering reaction force based on the FB axial force that enables the driver to be appropriately informed of vehicle behavior.
(4) When the FF axial force Fff is greater than or equal to a fifth predetermined value and the FB axial force is less than a sixth predetermined value, the road surface may be determined to be a low μ road surface. Because of this configuration, whether or not the road surface is a low μ road surface can be determined with a simpler configuration.
(5) A larger first predetermined value is set when a bank angle of the road surface is large than when the bank angle is small. Because of this configuration, influence of estimation error of the FB axial force Ffb due to a bank can be reduced.

### REFERENCE SIGNS LIST

1a Steering wheel
1b Steering shaft
2 Front wheel
3 Steering angle sensor
4 Turning angle sensor
5 Vehicle speed sensor
6 Acceleration sensor
7 Yaw rate sensor
8 Turning control unit
8A Turning motor
8B Turning current detection unit
9 Reaction force control unit
9A Reaction force motor
9B Reaction force current detection unit
10a Steering rack
10b, 10d Pinion shaft
10c, 10e Pinion P gear
12 Backup clutch

1. A steering control method for, in a vehicle in which a steering wheel and a steered wheel are mechanically separated, calculating feedforward axial force and feedback axial force, the feedforward axial force being steering rack axial force providing steering reaction force to be transmitted to a steering rack when the steering rack connected to the steered wheel is driven by a turning motor in response to steering of the steering wheel, and the feedback axial force being steering rack axial force to be transmitted from a road surface on which the vehicle is traveling to the steering rack via the steered wheel, and providing the steering wheel with steering reaction force, based on at least one of the feedforward axial force and the feedback axial force, the steering control method comprising:
estimating a front wheel slip angle, the front wheel slip angle being a slip angle of the steered wheel;
determining whether or not the road surface is a low μ road surface, the low μ road surface having a friction coefficient less than or equal to a threshold value;
when the road surface is a low μ road surface and an axial force difference between one of model axial force, the model axial force being steering rack axial force matching an actual turning angle of a steered wheel, and the feedforward axial force and the feedback axial force is less than a first predetermined value, providing steering reaction force based on the feedforward axial force without using the feedback axial force;
when the road surface is a low μ road surface and the axial force difference is greater than or equal to the first predetermined value, providing steering reaction force based on the feedback axial force;
when the road surface is not a low μ road surface and the front wheel slip angle is less than a third predetermined value, providing steering reaction force based on the feedforward axial force without using the feedback axial force; and
when the road surface is not a low μ road surface and the front wheel slip angle is greater than or equal to the third predetermined value, providing steering reaction force based on the feedback axial force.

2. The steering control method according to claim 1 comprising:
when the road surface is a low μ road surface and the axial force difference is greater than or equal to the first predetermined value and less than a second predetermined value, the second predetermined value being greater than or equal to the first predetermined value, providing steering reaction force based on mixed axial force obtained by mixing the feedforward axial force and the feedback axial force; and
when the road surface is not a low μ road surface and the front wheel slip angle is greater than or equal to the third predetermined value and less than a fourth predetermined value, the fourth predetermined value being greater than or equal to the third predetermined value, providing steering reaction force based on mixed axial force obtained by mixing the feedforward axial force and the feedback axial force.

3. The steering control method according to claim 2 comprising, when steering velocity is greater than or equal to a predetermined velocity, providing steering reaction force based on the feedback axial force regardless of whether or not the road surface is a low μ road surface, whether or not the axial force difference is greater than or equal to the second predetermined value, and whether or not the front wheel slip angle is greater than or equal to the fourth predetermined value.

4. The steering control method according to claim 2 comprising:
detecting an actual yaw rate generated in the vehicle and vehicle speed of the vehicle, using a sensor;
calculating a model yaw rate, the model yaw rate being a model value of a yaw rate generated in the vehicle, based on a turning angle of the steered wheel, vehicle speed of the vehicle, and a vehicle model; and
when a difference between the model yaw rate and the actual yaw rate is greater than a predetermined value, providing steering reaction force based on the feedback axial force regardless of whether or not the road surface is a low μ road surface, whether or not the axial force difference is greater than or equal to the second predetermined value, and whether or not the front wheel slip angle is greater than or equal to the fourth predetermined value.

5. The steering control method according to claim 2 comprising:
detecting an actual yaw rate and lateral acceleration generated in the vehicle and vehicle speed of the vehicle, using a sensor;
calculating model vehicle body slip angular velocity, the model vehicle body slip angular velocity being a model value of vehicle body slip angular velocity generated in the vehicle, based on a turning angle of the steered wheel, vehicle speed of the vehicle, and a vehicle model;
calculating actual vehicle body slip angular velocity, based on the actual yaw rate, the lateral acceleration, and the vehicle speed; and
when a difference between the model vehicle body slip angular velocity and the actual vehicle body slip angular velocity is greater than a predetermined value, providing steering reaction force based on the feedback axial force regardless of whether or not the road surface is a low μ road surface, whether or not the axial force difference is greater than or equal to the second predetermined value, and whether or not the front wheel slip angle is greater than or equal to the fourth predetermined value.

6. The steering control method according to claim 1, wherein when the feedforward axial force is greater than or equal to a fifth predetermined value and the feedback axial force is less than a sixth predetermined value, the steering control method determines that the road surface is a low μ road surface.

7. The steering control method according to claim 1, wherein the steering control method sets a larger first predetermined value when a bank angle of the road surface is large than when the bank angle is small.

8. A steering control device comprising:
a steering angle sensor configured to detect, in a vehicle in which a steering wheel and a steered wheel are mechanically separated, a steering angle of the steering wheel;
a reaction force motor configured to provide the steering wheel with steering reaction force; and
a controller configured to calculate feedforward axial force and feedback axial force, the feedforward axial force being steering rack axial force providing steering reaction force to be transmitted to a steering rack when the steering rack connected to the steered wheel is driven by a turning motor in response to steering of the steering wheel, the feedback axial force being steering rack axial force to be transmitted from a road surface on which the vehicle is traveling to the steering rack via the steered wheel, and cause the reaction force motor to generate steering reaction force to be provided to the steering wheel, based on at least one of the feedforward axial force and the feedback axial force,
wherein the controller:
estimates a front wheel slip angle, the front wheel slip angle being a slip angle of the steered wheel; determines whether or not the road surface is a low μ road surface, the low μ road surface having a friction coefficient less than or equal to a threshold value; when the road surface is a low μ road surface and an axial force difference between one of model axial force, the model axial force being steering rack axial force matching an actual turning angle of a steered wheel, and the feedforward axial force and the feedback axial force is less than a first predetermined value, causes the reaction force motor to generate steering reaction force based on the feedforward axial force without using the feedback axial force; when the road surface is a low μ road surface and the axial force difference is greater than or equal to the first predetermined value, causes the reaction force motor to generate steering reaction force based on the feedback axial force; when the road surface is not a low μ road surface and the front wheel slip angle is less than a third predetermined value, causes the reaction force motor to generate steering reaction force based on the feedforward axial force without using the feedback axial force; and when the road surface is not a low μ road surface and the front wheel slip angle is greater than or equal to the third predetermined value, causes the reaction force motor to generate steering reaction force based on the feedback axial force.
